(19) United States
(12) Patent Application Publication
(10) Pub. No.: US 2026/0329233 A1
(43) Pub. Date: Oct. 22, 2026

(54) PRODUCTION METHOD OF A WRISTWATCH

(71) Applicant: SBANG S.R.L., TORINO (TO) (IT)

(72) Inventor: Andrea MURER, TORINO (TO) (IT)

(73) Assignee: SBANG S.R.L., TORINO (TO) (IT)

(21) Appl. No.: 19/117,415

(22) PCT Filed: Oct. 12, 2023
(86) PCT No.: PCT/IB2023/060284

§ 371 Date: Apr. 1, 2025

(30) Foreign Application Priority Data
Oct. 12, 2022 (IT) 102022000021012

(51) Int. Cl. G04B 37/22; G04B 37/11

(52) U.S. Cl. CPC G04B 37/223; G04B 37/11

(57) ABSTRACT

A production method of a wristwatch comprises the phases of having a clockwork mechanism available; having a containment body available provided with a cavity adapted to contain the clockwork mechanism, the containment body being made at least partly of a metal material; having a crystal available adapted to be applied above the cavity; having a back case available adapted to be applied below the cavity; having at least one polymeric material available; co-molding the polymeric material with the containment body, the co-molded polymeric material defining an at least partial coating of the containment body, concealing it at least partly from view; placing at least one part of the clockwork mechanism in the cavity; and applying the crystal and the back case to the containment body to close the cavity above and below.

### TECHNICAL FIELD

The present invention relates to a production method of a wristwatch.

### BACKGROUND ART

As is well known, wristwatches generally have a case whose function is to contain and protect a clockwork mechanism to keep it in place and avoid shocks and contact with unwanted elements.

Usually, the case has at least one central body called the “carrure” which is closed at the top by a transparent element called the “crystal” and at the bottom by a so-called “back case”. The carrure is a cylindrical-shaped element that has a cavity adapted to contain the clockwork mechanism. The back case, on the other hand, forms the bottom of the case and is usually intended to contact the wearer's wrist when the watch is worn. Finally, the crystal is the upper part of the case and is intended to remain visible so that the user can see the time indicated by the clockwork mechanism.

There are well-known wristwatches considered to be of high quality in which the case is made of a metal material. The use of the metal material has the advantage of being able to make watches that undergo limited changes in their dimensions as the temperature to which they are subjected changes, thus being able to ensure that the case seals well.

However, the metal material has several aesthetic drawbacks since it is difficult to model and has substantially one color, consequently reducing the possibilities for aesthetic customization of the watch. Therefore, the metal material is poorly suited for making watches having complex and articulated aesthetic shapes.

An additional drawback of metal is that its extreme rigidity results in direct transfer of shock and vibration from the case to the clockwork mechanism, consequently increasing the risk of damage or malfunction thereof.

Wristwatches are also known in which the case is made of a plastic material. Plastic material, as opposed to metal, has the advantage of being easily moldable, thus being able to make watches having different aesthetic conformations and colors. In addition to this, the plastic material can effectively absorb any shocks and vibrations, thus decreasing the risk of damage to the clockwork mechanism compared to a metal material.

On the other hand, plastic material has the drawback that it is not very durable and undergoes large variations in size as the temperature to which it is subjected changes, thus failing to ensure a good seal of the watch, especially to the infiltration of liquids such as water.

### DESCRIPTION OF THE INVENTION

Therefore, the main aim of the present invention is to devise a production method of a wristwatch by means of which wristwatches having good durability can be obtained and, at the same time, able to provide a high degree of aesthetic customization to meet the different aesthetic needs of users.

Another object of the present invention is to develop a production method of a wristwatch which can ensure that the watch is hermetically sealed against the infiltration of liquids such as water, while providing a high degree of aesthetic customization.

Another object of the present invention is to devise a production method of a wristwatch which can overcome the aforementioned drawbacks of the prior art within the framework of a simple, rational, easy and affordable to use as well as cost-effective solution.

The aforementioned objects are achieved by the present production method of a wristwatch having the characteristics of claim 1.

The aforementioned objects are achieved by this wristwatch having the characteristics of claim 8.

### BRIEF DESCRIPTION OF THE DRAWINGS

Other characteristics and advantages of the present invention will become more apparent from the description of a preferred, but not exclusive, embodiment of a production method of a wristwatch, illustrated by way of an indicative, yet non-limiting example, in the attached tables of drawings in which:

FIG. 1 is a perspective view of a wristwatch produced in accordance with the present invention,

FIG. 2 is a perspective view of the wristwatch case in FIG. 1,

FIG. 3 is an exploded view of the wristwatch in FIG. 1,

FIG. 4 is a cross-sectional perspective view of the case in FIG. 2,

FIG. 5 is a perspective view of a mold used to carry out the co-molding phase according to the invention.

### EMBODIMENTS OF THE INVENTION

With particular reference to these figures, reference numeral 1 globally denotes a wristwatch produced by means of the production method of a wristwatch according to the invention.

The method comprises the phase of having a clockwork mechanism 2 available. The clockwork mechanism 2 is configured to indicate the time. Preferably, the clockwork mechanism 2 is of the type of an analog mechanism. However, it cannot be ruled out that the clockwork mechanism may be of another type, such as e.g. digital.

The method then comprises the phase of having a containment body 3 available provided with a cavity 4 adapted to contain the clockwork mechanism 2. Specifically, the containment body 3 is conformed to be able to accommodate at least part of the clockwork mechanism 2 internally in the cavity 4. In addition, the containment body 3 is configured to allow the clockwork mechanism 2 to be mounted internally in the cavity 4 in order to keep it in a substantially fixed position.

Conveniently, the containment body 3 is made at least partly of a metal material. Preferably, the containment body 3 is made completely of a metal material, such as e.g. steel or similar materials.

The method also comprises the phase of having a crystal 5 available adapted to be applied above the cavity 4. The crystal 5 is intended in use to remain visible so that the user can see the time indicated by the clockwork mechanism 2.

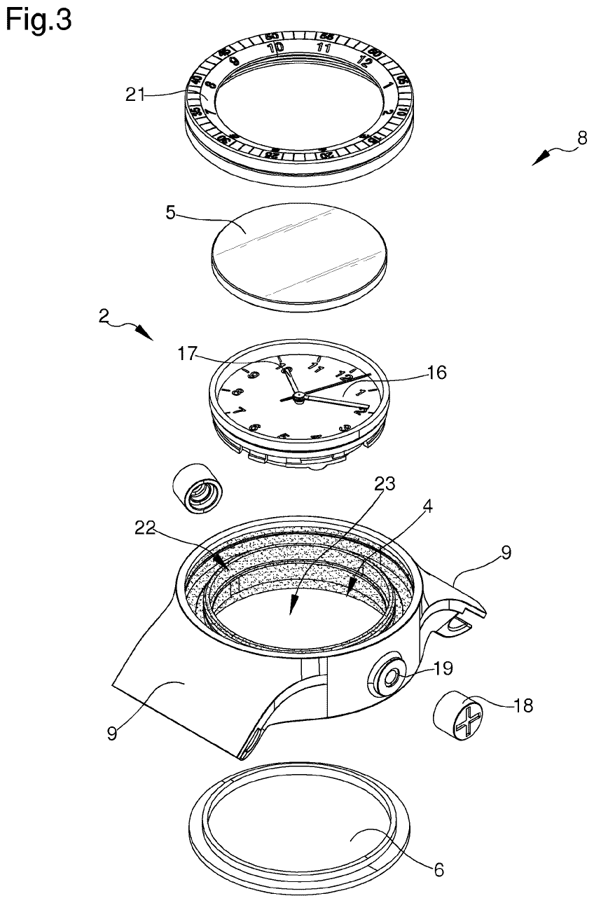

In the context of this disclosure, the terms “upper” and “lower”, “vertical” and “horizontal”, used with reference to the wristwatch 1, are meant to refer to the conditions under which the wristwatch is normally used, i.e., those in which it is worn by a user and is arranged as in FIG. 3.

Preferably, the term “crystal” refers to the substantially transparent case element of a watch which is intended to cover the dial to protect it and enable a user to watch the time.

The method also comprises the phase of having a back case 6 available adapted to be applied below the cavity 4. Specifically, the back case 6 is adapted to be arranged against the crystal 5. In use, the back case 6 is adapted to be arranged against the wrist of a user.

Conveniently, the method comprises the phase of having at least one polymeric material available.

Advantageously, the method comprises the phase of co-molding the polymeric material with the containment body 3, the co-molded polymeric material defining an at least partial coating 7 of the containment body 3, concealing it at least partly from view. In detail, the coating 7 is achieved by the polymeric material co-molded with containment body 3. The coating 7 and the containment body 3 form the so-called case 8 of the watch 1.

This arrangement makes it possible to obtain a case 8 which has the advantages of metal and, at the same time, those of the polymeric material. In particular, the metal containment body 3 gives the case 8 high strength and an extremely effective seal. Such a feature also makes it possible, as we shall see later in the disclosure, to make a watch which is substantially water-resistant. The coating 7 made of co-molded polymeric material gives a high degree of customization to the watch 1 which allows for the production of watches having a variety of different aesthetic conformations, even very complex ones, thus succeeding in making watches that are aesthetically more attractive and customizable according to the tastes of the end consumer.

The method comprises a phase of placing at least part of the clockwork mechanism 2 into the cavity 4. Specifically, this phase involves mounting the clockwork mechanism 2 to the containment body 3, placing at least one part of it in the cavity 4.

In addition, the method comprises the phase of applying the crystal 5 and the back case 6 to the containment body 3 to close the cavity 4 above and below.

This phase is carried out subsequently to the positioning of the clockwork mechanism 2.

Preferably, the phase of positioning and the phase of applying mentioned above are carried out subsequently to the phase of co-molding. That is, the clockwork mechanism 2 is placed in the cavity 4 subsequently to the co-molding of the coating 7 with the containment body 3. Consequently, the application of the crystal 5 and of the back case 6 occurs after the positioning of the clockwork mechanism 2, and then subsequently to co-molding.

Conveniently, the crystal 5 and the back case 6 are applied sealed to the containment body 3 to close the cavity 4 in a waterproof manner. In other words, the crystal 5 and the back case 6 are applied sealed to the containment body 3 to substantially seal the cavity 4 in order to prevent the flow of at least the fluids, such as e.g. water.

Because the containment body is made of metal, such a sealed connection is very efficient even when the watch 1 is subjected to large temperature variations.

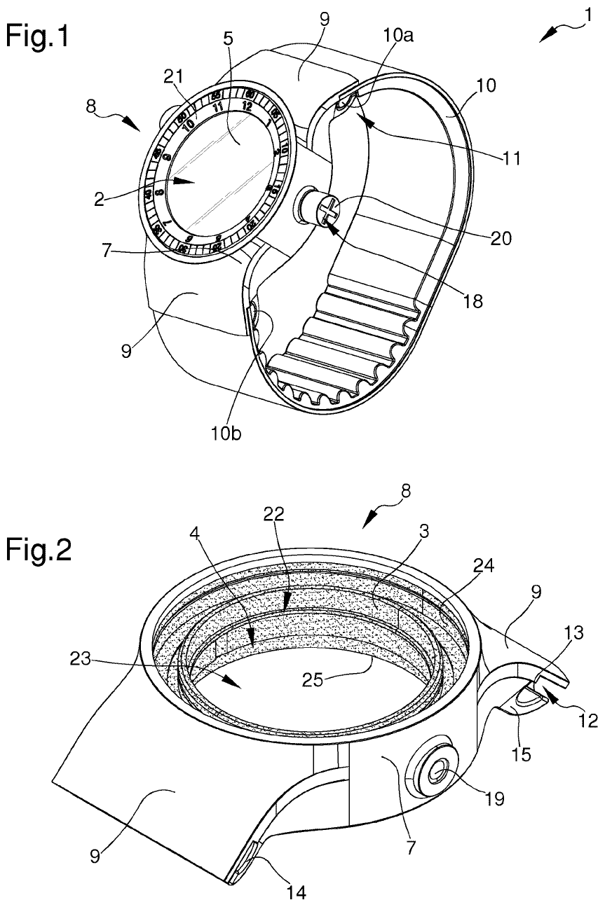

As visible from FIGS. 1 and 3, the coating 7 has a pair of tabs 9, each configured to make a connection with one end 10a, 10b of a strap 10. In actual facts, the co-molding of the polymeric material with the containment body 3 is made in such a way as to obtain a coating 7 provided with the pair of tabs 9. In other words, the pair of tabs 9, being part of the coating 7, are also made during the co-molding of the polymeric material with the containment body 3.

The method then comprises the phase of having a strap 10 available provided with a pair of ends 10a, 10b, and the phase of connecting the ends 10a, 10b of the strap 10 to the tabs 9 of the coating 7.

For this purpose, each tab 9 comprises removable connecting means 11 to one end 10a, 10b of the strap 10. In particular, the connecting means 11 are provided with a housing seat 12 adapted to accommodate the end 10a, 10b of the strap 10 in a removable manner. In particular, the housing seat 12 is shaped to make a connection to the end 10a, 10b of the strap 10 by interlocking.

Preferably, the housing seat 12 has a groove 13 cut transversely to the tab 9. The groove 13 extends between one pair of side openings 14, each adapted to allow the insertion of the end 10a, 10b of the strap by sliding into the groove 13.

The housing seat 12 then comprises an engagement element 15 adapted to engage with the end 10a, 10b of the strap 10 to secure it into the housing seat 12.

As can be seen from FIG. 1, each end 10a, 10b of the strap 10 can be inserted laterally and to size within its respective housing seat 12. More specifically, the insertion of the end 10a, 10b is carried out by holding the case 8 fixed, by moving the end 10a, 10b into the side opening 14 and sliding it until it occupies the housing seat 12 to size, thus allowing the engagement element 15 to engage with the strap 10.

To disengage the end 10a, 10b from the housing seat 12, it is sufficient to manually force the exit of the end 10a, 10b from the housing seat 12 by disengaging the engagement element 15 from the strap 10.

As anticipated above, the clockwork mechanism 2 is a system configured to indicate time. The clockwork mechanism 2 is known in the state of the art, so its operation will not be discussed in detail later in this description. Preferably, the clockwork mechanism 2 is of the analog type.

The clockwork mechanism 2 comprises at least one dial 16. The dial 16 is a substantially flat element on which time indicator symbols, such as hours, minutes, seconds, or other functions are marked. The dial 16 is arranged facing the crystal 5 so that it can be seen by a user.

The clockwork mechanism 2 then comprises one or more hands 17 which are associated in a rotating manner with the dial 16 so as to indicate the hours, minutes, and, preferably, the seconds shown on the latter.

The hands 17 are moved by a central mechanism comprising a motor and a series of gears located between the motor and the hands 17 to transmit the rotary motion thereof according to a preset rotational speed depending on whether the hand is adapted to indicate hours, minutes or seconds.

As visible from FIG. 3, the clockwork mechanism 2 comprises at least one crown 18. The crown 18 is operationally connected to the hands 17 to control and adjust the positioning thereof. The crown 18 is adapted to be gripped by the user in order to be able to set the time.

Conveniently, the coating 7 is provided with a passage hole 19 of the crown 18 adapted to make the latter accessible from the outside of the coating 7.

The phase of positioning the clockwork mechanism 2 comprises a phase of connecting the crown 18 to the containment body, preferably by means of a screw lock.

Appropriately, the method comprises a phase of having a covering element 20 of the crown 18 available. In addition, the method comprises a phase of applying the covering element 20 to the crown 18 to cover it.

Conveniently, the covering element 20 is also made of polymeric material. Specifically, preferably, the method provides for the co-molding of the polymeric material with the crown 18 to make the covering element 20 and thus to apply it to the crown 18.

In this way, the covering element 20 is applied to the crown 18 so as to close the hole in a waterproof manner.

Preferably, the watch 1 comprises at least one bezel 21 movably coupled in rotation to the containment body 3 to rotate substantially around the dial 16. The bezel 21 is provided with at least one indicative scale for reading a time datum.

Even more preferably, the watch 1 comprises a pair of bezels 21 arranged concentrically to each other, one surrounding the other.

The bezels 21 are mounted on the containment body 3 so that they substantially surround the dial 16.

As illustrated in FIG. 2, the containment body 3 has a substantially ring-shaped conformation bordering the cavity 4. It cannot, however, be ruled out that the containment body 3 may have a different conformation.

In addition, the containment body 3 has a pair of access openings 22, 23 to the cavity 4 opposite each other. Specifically, the containment body 3 has an upper opening 22 intended to be closed by the crystal 5, and a lower opening 23 intended to be closed by the back case 6.

The containment body 3 then comprises an upper end portion 24 and a lower end portion 25 arranged in the proximity of the upper opening 22 and of the lower opening 23, respectively. The end portions 24, 25 are conformed to make a sealed coupling with the crystal 5 and with the back case 6, respectively.

As visible from FIG. 3, the back case 6 is a substantially plate-shaped element adapted to close the lower opening 23 of the containment body 3, thus making the bottom of the case 8 of the watch 1.

Preferably, the back case 6 is made at least partly of metal.

Preferably, the back case 6 is removably associated with the containment body 3.

For this purpose, securing means for securing the back case to the containment body 3 are provided. For example, the securing means may be a plurality of holes made on the back case and/or on the containment body and adapted to receive a securing member, such as e.g. a screw.

As anticipated above, the coating 7 is made by co-molding the polymeric material with the containment body 3.

To this end, advantageously, the phase of co-molding comprises the sub-phase of having at least one mold 26 available which defines at least one chamber 27 having a predefined shaping. The chamber 27 is adapted to accommodate the containment body 3 so as to define with the latter a compartment 28 surrounding at least partly the containment body 3. In actual facts, the mold 26 has a dedicated space which is intended to be occupied by the containment body 3. Once the containment body 3 has been placed in the designated space, the walls of the latter and those of the mold 26 define the compartment 28. The compartment 28 is intended to receive the polymeric material so that the latter surrounds the containment body 3.

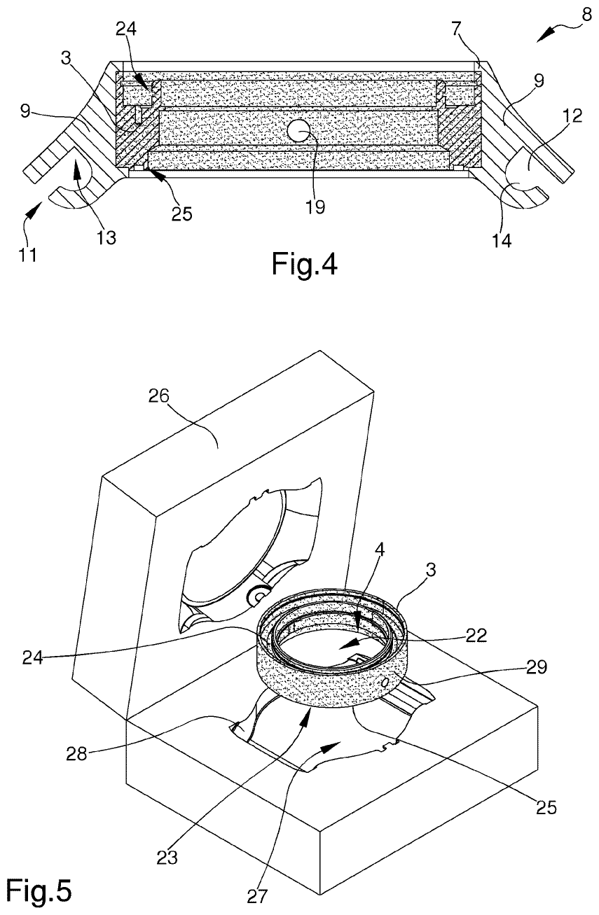

As can be seen in FIG. 4, the shaping of the mold 26 is predetermined to obtain, as a result of co-molding, the coating 7 described above. By varying the shaping of the mold 26, it is possible to change the conformation of the coating 7 and thus of the aesthetic appearance of the watch 1 obtained by the method according to the invention.

Once the desired conformation of the watch 1 has been established, the mold is created with a shaping such that the compartment 28 has the negative shape of the coating 7.

Next, the method involves the phase of positioning the containment body 3 in the chamber of the mold 26, thus defining the compartment 28.

At this point, the method involves the phase of injecting the polymeric material in the molten state into the compartment 28. The injected polymeric material thus occupies substantially the entire compartment 28, shaping itself according to the shaping of the mold.

Finally, the method involves the phase of cooling the polymeric material so that it can solidify and maintain the predetermined shape, thus achieving the desired coating 7.

As can be seen from FIG. 2, preferably, the coating 7 obtained by co-molding with the containment body 3 has a substantially ring-shaped conformation surrounding the containment body 3. In particular, the coating 7 is substantially concentric with the containment body 3. In actual facts, the coating 7 has a substantially circular side wall which wraps around the containment body 3.

It cannot, however, be ruled out that the coating 7 may have different conformations depending on the mold used to make it.

The coating 7 then has a pair of openings that communicate with the openings of the containment body 3 so that the crystal 5 and the back case 6 can be attached to the latter.

As anticipated above, advantageously, co-molding between the coating 7 and the containment body 3 allows for wristwatches be obtained which can be customized in color and/or conformation.

Therefore, preferably, the phase of having a polymeric material available involves choosing the polymeric material from a plurality of polymeric materials having different colors. The coating 7 thus varies its color depending on the selected polymeric material. In other words, the method comprises the phase of making a plurality of polymeric materials available having different colors from each other, from which the polymeric material used for the production of a watch 1 can be selected.

With regard to shapes, the phase of having a mold 26 available involves choosing a mold 26 from a plurality of molds 26 having chambers 27 with different shaping from each other. The coating 7 varies its conformation depending on the chosen mold 26. In other words, the method comprises the phase of making a plurality of molds available having different conformations from each other, among which the mold 26 used for the production of a watch 1 can be selected.

Preferably, the method involves producing a plurality of wristwatches 1 having different colors and/or shapes from each other. To this end, at least one watch 1 is produced by selecting a polymeric material having a certain color and/or choosing a mold 26 having a certain shaping. Another watch 1 is produced by choosing another polymeric material having another color and/or choosing another mold 26 having another shaping.

The present invention also relates to a wristwatch 1.

As visible from FIG. 1, the watch 1 comprises:
a clockwork mechanism 2;
a containment body 3 provided with a cavity 4 adapted to contain the clockwork mechanism 2, the containment body 3 being made at least partly of a metal material;
a crystal 5 applied to the containment body 3 above the cavity 4;
a back case 6 applied to the containment body 3 below the cavity 4.

These elements have already been described above.

Advantageously, the watch 1 comprises a coating 7 of the containment body 3 made of a polymeric material co-molded with the containment body 3 to conceal it at least partly from view. The coating 7 has also been described in detail previously.

As anticipated above, the crystal 5 and the back case 6 are applied sealed to the containment body 3 to close the cavity 4 in a waterproof manner.

The watch 1 also comprises a strap 10 adapted to be wrapped around a user's wrist. The strap 10 extends between one pair of ends 10a, 10b.

Appropriately, as anticipated above, the coating 7 comprises at least one pair of tabs 9, each being configured to make a connection to one of the ends 10a, 10b of the strap 10.

It has in practice been ascertained that the described invention achieves the intended objects, and in particular, the fact is emphasized that by means of the production method of a wristwatch, it is possible to obtain wristwatches having good resistance and, at the same time, able to meet the various aesthetic requirements of the users. In particular, the method makes it possible to develop a production method of a wristwatch that can ensure that the watch is water-resistant and, at the same time, has a high degree of aesthetic customization.

1) A production method of a wristwatch, the production method comprising the phases of:
having a clockwork mechanism available;
having a containment body available provided with a cavity adapted to contain said clockwork mechanism, said containment body being made at least partly of a metal material;
having a crystal available adapted to be applied above said cavity;
having a back case available adapted to be applied below said cavity;
having at least one polymeric material available;
co-molding said polymeric material with said containment body, said co-molded polymeric material defining an at least partial coating of said containment body, concealing said containment body at least partly from view;
placing at least one part of said clockwork mechanism in said cavity; and
applying said crystal and said back case to said containment body to close said cavity above and below.

2) The production metho according to claim 1, wherein said crystal and said back case are applied to said containment body in a sealing manner to close said cavity in a waterproof manner.

3) The production method according to claim 1, wherein said coating has a pair of tabs, each configured to make a connection with one end of a strap.

4) The production method according to claim 1, wherein said co-molding phase comprises the sub-phases of:
having at least one mold available which defines at least one chamber having a predefined shaping, said chamber being adapted to accommodate said containment body to define with said containment body a compartment surrounding at least partly said containment body;
positioning said containment body in said chamber, thus defining said compartment; and
injecting said polymeric material in the molten state into said compartment.

5) The production method according to claim 1, wherein said phase of having a polymeric material available involves choosing said polymeric material from a plurality of polymeric materials having different colors, said coating varying its color depending on said selected polymeric material.

6) The production method according to claim 1, wherein said phase of having a mold available involves choosing said mold from a plurality of molds having chambers with different shaping from each other, said coating varying its conformation depending on said chosen mold.

7) The production method according to claim 1, further comprising the phases of:
having a strap available provided with a pair of ends, and
connecting said ends of said strap to said tabs of said coating.

8) A wristwatch comprising:
a clockwork mechanism
a containment body provided with a cavity adapted to contain said clockwork mechanism, said containment body being made at least partly of a metal material;
a crystal applied to said containment body above said cavity;
a back case applied to said containment body below said cavity; and
a coating of said containment body made of a polymeric material co-molded with said containment body to conceal said containment body at least partly from view.

9) The wristwatch according to claim 8, wherein said crystal and said back case are applied to said containment body in a sealing manner to close said cavity in a waterproof manner.

10) The wristwatch according to claim 8, further comprising: a strap adapted to be wrapped around a user's wrist, said strap extending between one pair of ends, wherein
said coating comprises at least one pair of tabs, each being configured to make a connection with one of said ends of said strap.
